(19) United States
(12) Patent Application Publication
(10) Pub. No.: US 2016/0098256 A1
(43) Pub. Date: Apr. 7, 2016

(54) VISUAL TOOL AND ARCHITECTING LOGICAL LAYERS OF SOFTWARE COMPONENTS

(71) Applicant: General Motors LLC, Detroit, MI (US)

(72) Inventors: Saeid Tehrani, Farmington Hills, MI (US); Aditya Aggarwal, Windsor (CA); Michael L. Dessert, Farmington Hills, MI (US)

(21) Appl. No.: 14/505,608

(22) Filed: Oct. 3, 2014

(51) Int. Cl. G06F 9/44; G06F 9/445

(52) U.S. Cl. CPC G06F 8/36; G06F 8/71; G06F 8/61; G06F 8/10

(57) ABSTRACT

A system and method of generating a software application using a software architecture tool includes: receiving a plurality of software component selections from a user via a computer; accessing one or more repositories stored on a computer-readable medium that define a plurality of software specifications; comparing the selected software components to the software specifications in the repositories; identifying compatibility features between the selected software components and the software specifications in the repositories; displaying the compatibility features of the selected components via a peripheral of the computer; and building a skeletal software application that includes the selected software components and one or more software components added based on compatibility features using one of the repositories stored on a computer-readable medium.

### TECHNICAL FIELD

The present invention relates to the architecture of software applications and, more particularly, to visually determining interdependencies that exist between software components as well as whether components of the software applications are standard components or non-standard components.

### BACKGROUND

Software applications control the operation or function of a wide variety of mechanical and electrical devices. As the functions of these systems/devices have become increasingly complex, the architecture and design of the software applications have also become more complex as well. Software applications often include an interrelated structure of different software components that work in harmony. However, as software applications include increasing numbers of software components, the chance increases that some of these software components are incompatible with each other. Also, it is possible that one software component that has been added to the software application may require the presence of another software component to properly function. When software designers or architects create software applications with many software components that have dependencies or incompatibilities with other components, it can be challenging to identify the requirements of each software component. Although layering can group components for better organization and modularization of the system, it may not be able to address the above dependencies or incompatibilities.

### SUMMARY

According to an embodiment, there is provided a method of generating a software application using a software architecture tool. The steps include receiving a plurality of software component selections from a user via a computer; accessing one or more repositories stored on a computer-readable medium that define a plurality of software specifications; comparing the selected software components to the software specifications in the repositories; identifying compatibility features between the selected software components and the software specifications in the repositories; displaying the compatibility features of the selected components via a peripheral of the computer; and building a skeletal software application that includes the selected software components and one or more software components added based on compatibility features using one of the repositories stored on a computer-readable medium.

According to another embodiment, there is provided a method of generating a software application using a software architecture tool. The steps include receiving a tier selection and a software component selection from a user; determining whether the software component selection is standard or non-standard based on data accessed from an IT standard catalog; identifying dependencies between the software component selection and other software components in an enterprise component specification knowledge base; and building a skeletal software application based on the identified dependencies, wherein the skeletal software application includes data from an enterprise component binary repository.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a computer system that is capable of utilizing the method disclosed herein;

FIG. 2 is a flow chart depicting an embodiment of a method of generating a software application structure using a software architecture tool; and

FIG. 3 is a flow chart depicting another embodiment of a method of generating a software application structure using a software architecture tool;

FIG. 4 is a flow diagram of the inputs and outputs of a software architecture tool; and

FIG. 5 is a screen shot depicting an embodiment of a graphical user interface (GUI) of the software application.

### DETAILED DESCRIPTION OF THE ILLUSTRATED EMBODIMENTS

The system and method described below implements a software architecture tool that can design software applications with multiple software components in various layers and tiers organized by appropriate placement of each software component in a particular layer within a tier. The software architecture tool can visually display a software application within a layer as a grouping of software components of a software tier. The components can be selected by a software architect or user, placed in a particular tier and layer, and cross-referenced with one or more repositories, such as an IT standards catalog, an enterprise component specification knowledge base, an enterprise component binary repository, or an enterprise component template repository. The software architecture tool can receive input from any one or more of the repositories, determine any co-dependencies or conflicts that exist between selected software components using information found in the repositories, and automatically add software components based on the co-dependencies.

For example, the software architecture tool can search the IT standards catalog to identify a selected software component as a standard component or a non-standard component. Standard software components can be components that are identifiable in the IT standards catalog. In contrast, if the selected software component cannot be identified in the IT standards catalog, the software architecture tool can classify the component as non-standard and prompt the user to input the location or identity of the software component. The software architecture tool can also identify dependencies between software components by accessing the enterprise component specification knowledge base. After each software component has been selected by the user and any dependencies have been resolved using the enterprise component specification knowledge base, the software architecture tool can generate an IT bill of material (IT BOM) containing a list of standard and non-standard materials. The software architecture tool can then place the selected components on appropriate layers, generate build descriptors using the enterprise component template repository, and then generate a skeletal software application comprising the selected components using the enterprise component binary repository that identifies the software binary components in the designed software application. The software architecture tool can also identify incompatibilities of the software components and output the incompatibilities as an incompatibility report using the enterprise component specification knowledge base.

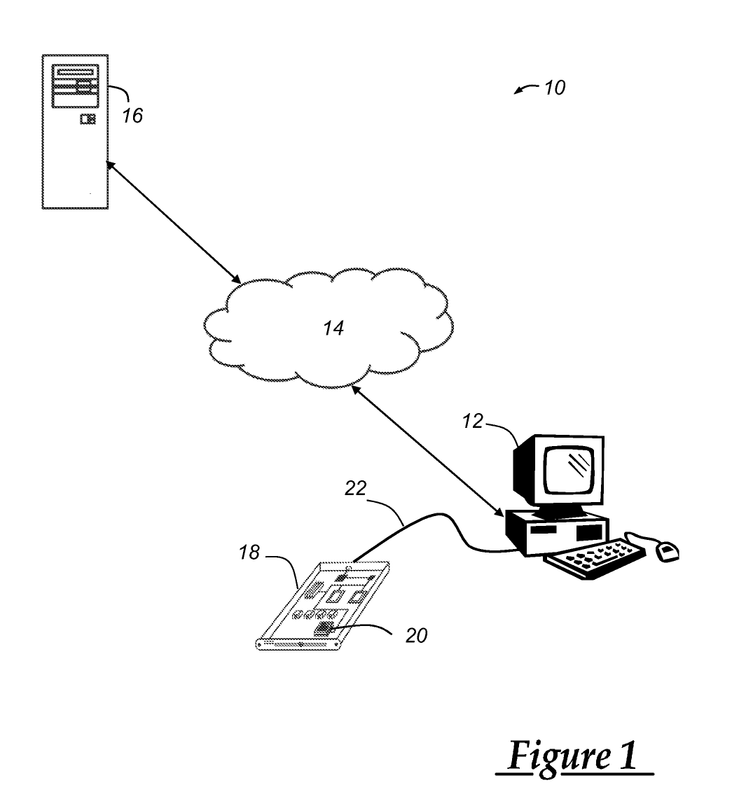

With reference to FIG. 1, there is shown a computing system 10 that can be used to implement the software development tool described below. The system 10 generally includes a personal computer (PC) 12 and, optionally, a land communications network 14 connected to a remotely-located computer 16. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such computing system 10; however, other systems not shown here could employ the disclosed method as well.

Personal computer (PC) 12 can be a computing device operated by a software architect or designer that includes hardware in the form of one or more microprocessors, memory devices, peripherals, and modems. A typical PC 12 can receive input from peripherals such as a keyboard and a mouse and output information via other peripherals, such as a monitor. In this arrangement, it is common for the PC 12 to be remain stationary on a desktop or other similar location. However, it is also possible to implement the PC 12 as a portable device having many if not all of the elements discussed above, such as a laptop or handheld computer (not shown). The microprocessors of the PC 12 can include a central processing unit (CPU) that executes software or software instructions in form of computer-readable code. The software can be stored in the memory device, which can be any type of non-volatile memory as is known in the art. Communications between the CPU and other hardware elements can be carried out over a bus, as can be implemented using a printed circuit board (PCB). In one implementation, the PC 12 can use the CPU to access software that carries out the software architecture tool and is stored in the memory devices of the PC 12. A user of the software architecture tool can provide input and receive output using peripherals of the PC 12, such as the keyboard, the mouse, or the visual display. In addition to software implementing the software architecture tool, the memory devices can store one or more databases containing an IT standard catalog and a software repository. When executing the software architecture tool, the CPU can access the IT standard catalog and a software repository in response to user input.

The PC 12 can be communicatively linked to a microcontroller 18 having a microprocessor 20. The PC 12 can then uses its CPU to write computer-readable instructions to the memory portion of the microprocessor 20 in the form of a software application. The computer readable instructions can be sent from the PC 12 to the microprocessor 20 of the microcontroller 18. In one implementation, the PC 12 is connected via a data cable 22 having connectors on each end, such as universal serial bus (USB) connectors, that bi-directionally carries data between the PC 12 and the microcontroller 18.

In some implementations, the databases containing an IT standard catalog and a software repository may be located remote from the PC 12 at the remotely-located computer 16. In that case, the PC 12 can be linked with the computer 16 via the land network 14. The land network 14 may be a conventional land-based telecommunications network that is connected to one or more landline telephones. For example, land network 18 may include a public switched telephone network (PSTN) such as that used to provide hardwired telephony, packet-switched data communications, and the Internet infrastructure. One or more segments of land network 14 could be implemented through the use of a standard wired network, a fiber or other optical network, a cable network, power lines, other wireless networks such as wireless local area networks (WLANs), or networks providing broadband wireless access (BWA), or any combination thereof.

The remotely-located computer 20 can be one of a number of computers accessible via a private or public network such as the Internet. The remotely-located computer 20 can act as a repository for the software architecture tool, the IT standard catalog, or the software repository. Rather than maintaining the software and databases locally at the PC 12, it may access the remotely-located computer 20 to obtain this information.

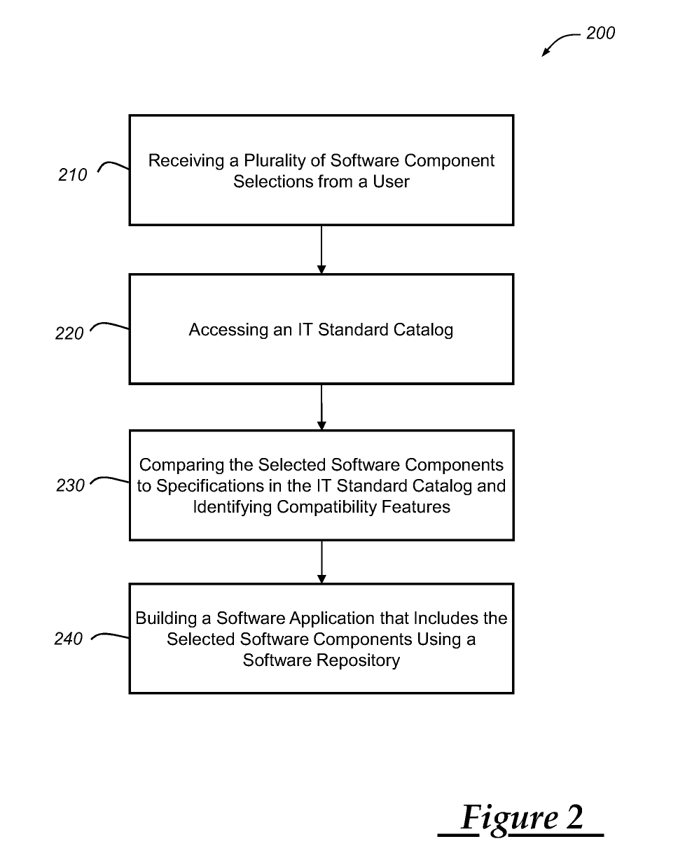

Turning now to FIG. 2, there is shown an embodiment of a method 200 of generating a software application structure using a software architecture tool. The method 200 begins at step 210 by receiving a plurality of software component selections from a software architect or user via a peripheral of the PC 12. Software designers or users of the PC 12 can model a software application using the PC 12 by selecting software components that are visually displayed using a mouse or keyboard. The PC 12 can present the user a graphical user interface (GUI) that includes a plurality of software components on one side or section of the GUI. As part of selecting software components, a user can first select a software tier into which subsequent software component selections can be placed. Then, the user can identify one or more software components to be placed in the software tier. The software component(s) may also belong to more than one software layer. If so, the user may also be prompted to select which software layer(s) the software component belongs to.

The software components can be selected from visually-displayed images representing those components and combined into a visually-displayed software application shown on an opposite side or section of the GUI from the software components. The visually-displayed software application depicts not only the components but also software tiers and software layers. One example of such a GUI can be implemented using available software, such as Eclipse. A software tier can define a physical structure of the software component, such as the location of the software component in a computer network whereas the software layer can define a logical structure of the software component. The software components can be described as a set of computer-readable instructions that carry out a particular function. The software components can include subroutines, data types, and other computer-readable instructions that communicate with other software components and direct hardware elements in accordance with a prescribed function. In one implementation, individual software components can each be depicted using an icon or other unique symbol that identifies the software component to the user. When designing the software application, the user can select one or more software components with a mouse and drag the software component to a space on the GUI dedicated to assembling one or more software components of a software application. There, the software components can be organized according to the tier and/or layer of the software application. The method 200 proceeds to step 220.

At step 220, one or more repositories are accessed from a computer-readable medium. The repositories include an IT standard catalog, an enterprise component specification knowledge base, an enterprise component binary repository, and an enterprise component template repository. Once the user has selected the software components to be included in a software layer or tier and those components are displayed together by the PC 12, one or more of the repositories can be searched to identify the selected software components or relationships between the software components.

The IT standard catalog can be a database identifying software components that are recognized by a particular company or organization and used to verify the identity of the selected software components. The software components in the IT standard catalog can include a software identifier for each software component and be classified as enterprise standard, non-standard, a deviation, freeware, shareware, open source, or a commercial component that may or may not be associated with an enterprise licensing agreement (ELA). In addition, vehicle manufacturers often identify software components in an IT standard catalog as being acceptable for use in their vehicles. By ensuring that the electrical or electromechanical devices of a vehicle, such as a vehicle control module or other microcontroller, use a particular set of software components included in the IT standard catalog for particular devices, the vehicle manufacturer can better control the operation of their devices and vehicles. In one example, a software application can be designed for installation in a vehicle control module. And when software components are selected for inclusion in the software application, the IT standard catalog can identify any software components among the selected software components that may not be acceptable or approved for use with the vehicle or vehicle control module based on a software identifier.

The software components found in the IT standard catalog can be labeled “standard” because the components are known and approved for use in a vehicle or other particular application. However, there may also be times when software components not found in the IT standard catalog may be included in the software application design. In this case, the software component can be identified as a “non-standard” component and the user may be prompted to identify the name of the software component or the location (e.g., a URL) where the non-standard component can be found. Non-standard components can include freeware, shareware, or open source software not recognized by the IT standard catalog but such non-standard components are expected to be approved before the software application were used in vehicle production or IT production systems.

The enterprise component specification knowledge base can identify dependencies between displayed software components as well as any conflicts between the selected software components and any other software components in the software application. The identities of any software components that relate to or conflict with selected software components can be identified in the enterprise component specification knowledge base using software identifiers. Related software components can include any software component the selected software component depends on for successful operation. Conflicting software components can include software components that interfere with the operation of selected software components. The enterprise component binary repository can contain libraries of enterprise component binaries and their respective version numbers. And the enterprise component template repository can contain information about software application types, such as Java and .Net, as well as information that controls a layer definition, such as which components belong to what layer. The method 200 proceeds to step 230.

At step 230, the selected software components are compared to the software specifications in the repositories and compatibility features are identified between the selected software components and the software specifications stored in the repositories. The compatibility features of the selected components are then displayed via a peripheral of the PC 12. Compatibility features include determining when two or more selected software components are not operable when combined or when other more appropriate software components can be selected. When this occurs, the PC 12 can display the incompatible or more appropriate software components in a common color, such as red. The PC 12 could also automatically delete one or more of the incompatible software components or prompt the user to delete the software components.

The compatibility features can also include determining when one selected software component includes functionality that is reliant on the presence of another non-selected software component. Sometimes one selected software component is identified in the enterprise component specification knowledge base as being dependent on another non-selected software component. In that case, the PC 12 can automatically identify the non-selected software component and add it to the arrangement of selected software components on the display of the PC 12. Of the selected software components, the enterprise component specification knowledge base can be used to identify when the software components conflict with each other and when additional software components should be added to the software components selected by the user. Furthermore, the display of the PC 12 can also visually distinguish between enterprise standard software and non-standard software, such as by color variations. For instance, each software component that is standard, such that it is found in the IT standard catalog, can be colored one color, (e.g., green) whereas software components that are non-standard can be colored a different color (e.g., blue). The method 200 proceeds to step 240.

At step 240 a skeletal software application is built that includes the selected software components using the repositories, and the software architecture tool creates an IT BOM and an incompatibility report. Once the needed software components for a skeletal software application have been determined to be present, the PC 12 can access the enterprise component binary repository and/or the enterprise component template repository that includes actual code used to implement the software application. The software components can be verified as they are arranged to identify any conflicts that may be present and if no conflict exists a skeleton of the software application can be compiled. The skeletal software application can include binaries obtained from the enterprise component binary repository such that the skeleton is readable by a software compiler. In one implementation, the skeletal application can include physical Java packaging sample code, unit tests, and/or build artifacts for the software application. A number of software compilers can be used to carry this out, such as the integrated development environments (IDE) Eclipse, Rational Software Architect (RSA), Apache Ant, or Apache Maven. It is possible to include the software architecture tool as a software plug-in to the IDE. When the present method 200 is used with software compilers, the IT BOM can be created along with the skeletal software application. The IT BOM can include a build list of the physical implementation of the software components included with the created skeletal software application. The build list of the IT BOM may also identify software components by a catalog number when they have been determined to be standard. Once the skeletal software application is created, it can be written to a non-volatile memory device that is communicatively linked to the PC 12, such as a flash drive inserted into a USB port or a portion of a non-volatile memory of the PC 12. The method 200 then ends.

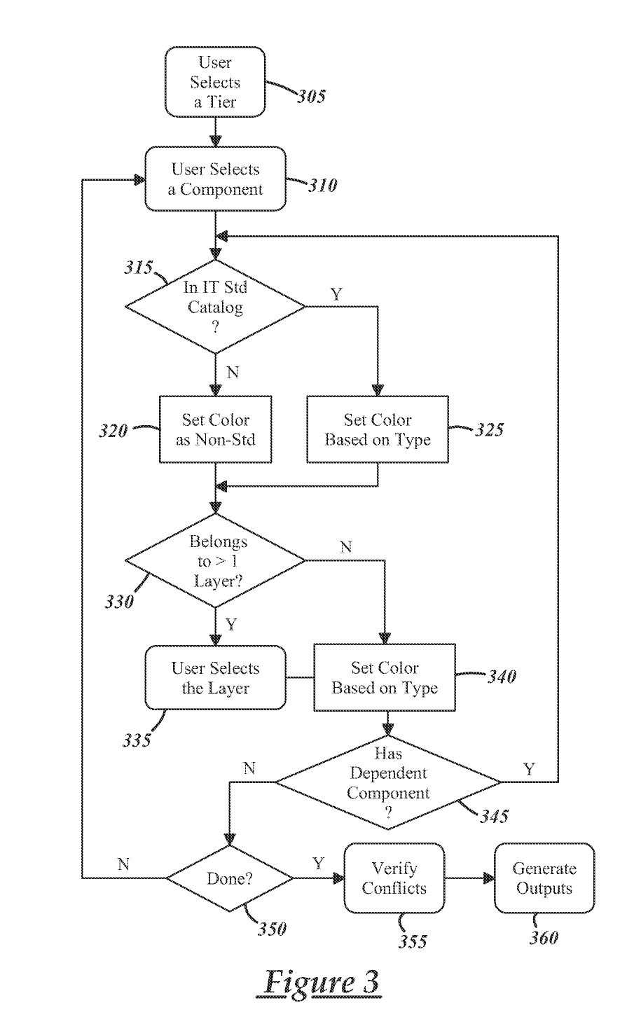

FIG. 3 depicts another embodiment of a method 300 of generating a software application structure using a software architecture tool. The method 300 begins at step 305 when a software tier is selected by the user. After selecting the tier, the method 300 proceeds to step 310 during which the user can select a software component to place in a layer. Once the tier and the software component have been selected, the method 300 proceeds to step 315.

At step 315, the software architecture tool can access the IT standard catalog and determine whether or not the selected software component is a standard software component or a non-standard component. If the selected software component is determined to be non-standard, the method 300 proceeds to step 320 and the software component can be identified on a peripheral of the PC 12 shown in FIG. 1 using a color that is common to non-standard software components. Otherwise, the method 300 proceeds to step 325 and the software component can be identified on a peripheral of the PC 12 of FIG. 1 using a color that is common to standard software components. The method 300 proceeds to step 330.

At step 330, the software architecture tool prompts the user to identify which layer the selected software component belongs to when the components are non-standard. When the components are standard, the software architecture tool can determine that the component only belongs to one layer and not prompt the user to identify the layer. However, for standard components that could belong to more than one layer, the software architecture tool can prompt the user to identify which layer the software component should be placed. If the selected software component belongs to more than one layer, the user can identify an additional layer in which to place the software component at step 335. Otherwise, the software architecture tool can assign the selected software component to the selected layer at step 340. The method 300 proceeds to step 345.

At step 345, the software architecture tool can determine whether or not the selected software component is dependent on other software components to function properly. To make this determination, the software architecture tool can access the enterprise component specification knowledge base and identify the selected component among stored software components and information associated with those stored software components. If the selected software component is determined to be dependent on other software components, the software architecture tool can select the dependent software component(s) and return to step 315. The dependent software components can then be processed as is described above beginning at step 315. If the selected software components are not determined to have dependent software components, the method 300 can proceed to step 350.

At step 350, the software architecture tool can determine whether or not the user would like to select additional software components. If so, the method 300 returns to step 310 and the software architecture tool can receive a software component selected by the user. Otherwise, the method 300 can proceed to step 355 and the software architecture tool can determine whether any conflicts exist among the selected software components. The method proceeds to step 360.

After identifying any conflicts, the software architecture tool can create a number of outputs. These outputs can include an incompatibility report identifying the conflicts between software components (if any) that can be based on a target operating system or a target application, a web server, or a container that are defined by a template in the enterprise component template repository. The outputs can also include an IT BOM, build descriptors, and a skeletal software application as described above. The method 300 then ends.

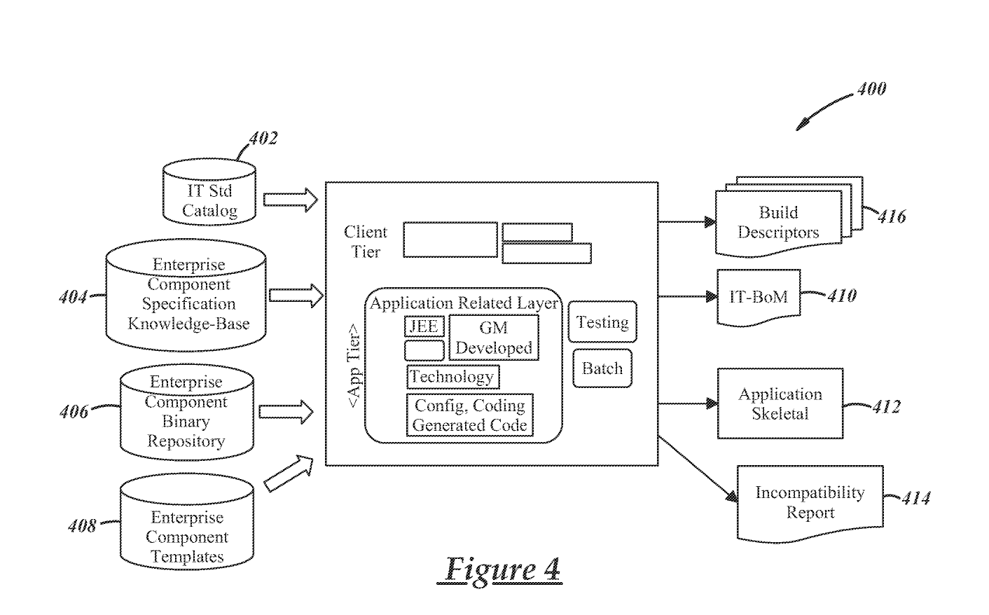

FIG. 4 depicts a flow diagram of the inputs and outputs of a software architecture tool 400. The software architecture tool 400 can receive inputs from any combination of the IT standard catalog 402, the enterprise component specification knowledge base 404, the enterprise component binary repository 406, or the enterprise component template repository 408. Using data from one or more of these repositories, the software architecture tool 400 can create the IT BOM 410, the skeletal application 412, the incompatibility report 414, build descriptors 416, or any combination of these outputs.

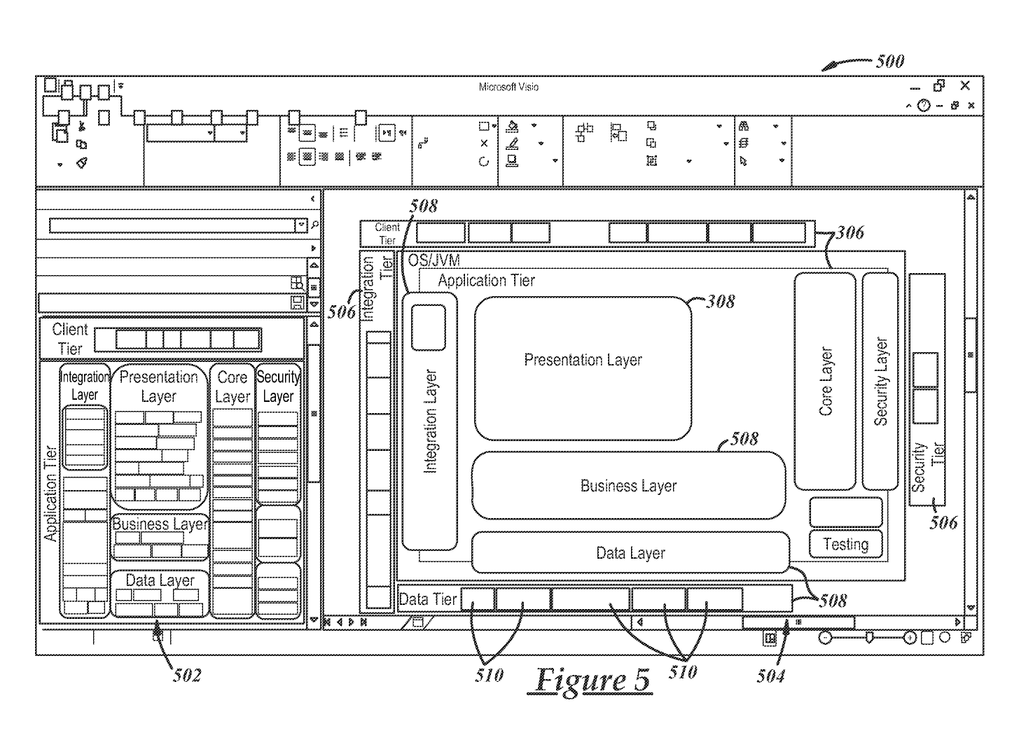

Turning to FIG. 5, there is shown an embodiment of a GUI for the software architecture tool. A screen shot of a GUI 500 as it would be displayed on a peripheral of the PC 12, such as a monitor, is shown in FIG. 5. A selection portion 502 of the GUI 500 can display software components offered to the user for designing a software application. The user can select one or more software components from the selection portion 502 and drag those components into a building section 504 of the GUI. The building section 504 can organize the software components into a software tier 506 in which one or more software layers 508 can be included.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of generating a software application using a software architecture tool, comprising the steps of:
(a) receiving a plurality of software component selections from a user via a computer;
(b) accessing one or more repositories stored on a computer-readable medium that define a plurality of software specifications;
(c) comparing the selected software components to the software specifications in the repositories;
(d) identifying compatibility features between the selected software components and the software specifications in the repositories;
(e) displaying the compatibility features of the selected components via a peripheral of the computer; and
(f) building a skeletal software application that includes the selected software components and one or more software components added based on compatibility features using one of the repositories stored on a computer-readable medium.

2. The method of claim 1, further comprising the step of generating an IT bill of materials (IT BOM) that identifies each component in a software application.

3. The method of claim 2, wherein the IT BOM includes non-selected software components that depend on selected software components.

4. The method of claim 1, further comprising the step of generating an incompatibility report.

5. The method of claim 1, further comprising the step of displaying compatibility features according to color.

6. The method of claim 1, wherein the compatibility features include a standard software component and a non-standard software component.

7. The method of claim 1, further comprising the step of verifying the plurality of software component selections for conflicts.

8. The method of claim 1, further comprising the step of receiving a software tier selection from the user for each software component selection.

9. The method of claim 1, further comprising the step of determining a software layer selection automatically for each software component selection or by user input that is constrained by an enterprise component template repository.

10. The method of claim 1, further comprising the step of building a vehicular software application.

11. The method of claim 10, further comprising the step of installing the vehicular software application on a vehicle.

12. A method of generating a software application using a software architecture tool, comprising the steps of:
(a) receiving a tier selection and a software component selection from a user;
(b) determining whether the software component selection is standard or non-standard based on data accessed from an IT standard catalog;
(c) identifying dependencies between the software component selection and other software components in an enterprise component specification knowledge base; and
(d) building a skeletal software application based on the identified dependencies, wherein the skeletal software application includes data from an enterprise component binary repository.

13. The method of claim 12, further comprising the step of generating an IT bill of materials (IT BOM) that identifies each component in a software application.

14. The method of claim 13, wherein the IT BOM includes non-selected software components that depend on selected software components.

15. The method of claim 12, further comprising the step of generating an incompatibility report.

16. The method of claim 12, further comprising the step of displaying the identified dependencies according to color.

17. The method of claim 12, further comprising the step of generating an incompatibility report.

18. The method of claim 12, further comprising the step of incorporating the skeletal software application into a vehicular software application.

19. The method of claim 18, further comprising the step of installing the vehicular software application on a vehicle.
